(19) United States
(12) Patent Application Publication
(10) Pub. No.: US 2022/0234942 A1
(43) Pub. Date: Jul. 28, 2022

(54) Colored Glass Frits And Related Methods For Automotive Applications

(71) Applicant: Ferro Corporation, Mayfield Heights, OH (US)

(72) Inventors: Enos A. Axtell, Seven Hills, OH (US); Anthony Polizzi, Hinckley, OH (US); Srinivasan Sridharan, Strongsville, OH (US); George E. Sakoske, Independence, OH (US)

(21) Appl. No.: 17/613,545

(22) PCT Filed: Jul. 15, 2020
(86) PCT No.: PCT/US2020/034164

§ 371 Date: Nov. 23, 2021

Related U.S. Application Data
(60) Provisional application No. 62/857,461, filed on Jun. 5, 2019.

(51) Int. Cl. C03C 4/02; C03C 8/02; C03C 8/04; C03C 8/16; C03C 3/091; C03C 3/093; C03C 3/064; C03C 3/066; C03C 1/04; C03C 17/02; C23D 5/02

(52) U.S. Cl. CPC C03C 4/02; C03C 8/02; C03C 8/04; C03C 8/16; C03C 3/091; C03C 3/093; C03C 2204/00; C03C 3/066; C03C 1/04; C03C 17/02; C23D 5/02; C03C 2207/00; C03C 3/064

(57) ABSTRACT

Glass frits and enamel compositions from the glass frits for use in automotive application. The enamel composition includes one or more glass frits with reduced amount of bismuth and/or zinc compared to reference enamel compositions available. The glass frits include one or more transition metal oxides. The glass frits exhibit improved chemical durability, reduced glass density, lower L-value, or optimized optical density for an end user depending on the applications.

### FIELD

The present subject matter relates to lead free colored glass frits containing transition metals for use in automotive applications and related methods.

### BACKGROUND

Colored enamels have long been used for forming an opaque, dark colored enamel bands on sections of automotive glass, such as windshields and side and rear windows. Automotive manufacturers have found that the appearance of a section of glass is greatly enhanced by applying a relatively narrow, opaque, dark colored enamel band around one or more edges of a section of glass on the inner surface thereof. In addition to imparting an aesthetically appealing appearance to the section of the glass, these opaque, colored enamel bands block the transmission of sunlight and thereby prevent the degradation of underlying adhesive by ultraviolet radiation. Moreover, these opaque colored enamel bands preferably conceal a section of the silver-containing buss bars and wiring connections of rear glass defrosting systems from view from the outside of the vehicle.

Colored enamels include one or more glass frits. The glass frits traditionally included lead to reduce fusing temperature of the glass frits. However, the use of lead in glasses has been reduced due to environmental and health issues. Depending on the application, lead can be replaced by bismuth or zinc. Therefore, it would be potentially desirable to prepare lead free glass frit composition without compromising their optical, thermal, and chemical properties.

### SUMMARY

The difficulties and drawbacks associated with previous approaches are addressed in the present subject matter as follows. This summary is not an extensive overview of the present subject matter. It is intended to neither identify key or critical elements of the present subject matter nor delineate the scope of the present subject matter. Its sole purpose is to present some concepts of the present subject matter in a simplified form as a prelude to the more detailed description that is presented later.

In accordance with one aspect, enamel compositions are provided that produce dark colors and improved optical, thermal and chemical properties. The enamel compositions comprise one or more glass frits and organic vehicles. The one or more glass frits are in fine powder form, and comprise about 0.1 to about 15 mol % Li₂O, about 5 to about 20 mol % Na₂O+K₂O+Rb₂O+Cs₂O, about 0.1 to about 20 mol % transition metal oxides, about 1 to about 45 mol % B₂O₃+Al₂O₃, about 20 to about 80 mol % SiO₂+TiO₂, and about 0 to about 40 mol % F. The transition metal oxides are one or more selected from Fe₂O₃, MnO₂, Cr₂O₃, and Co₃O₄. The glass frit does not include at least one of Bi and Zn.

In accordance with another aspect, multiple glass frits are provided that produce a mixed enamel compositions with controlled optical, thermal or chemical properties, About 1-95 wt. % dark colored glass frit according to present subject matter is blended with about 0-85 wt. % bright colored enamel composition to form an enamel layer on the substrate. Optionally, about 1 to 35 wt. % pigment and about 1-30 wt. % inorganic filler. About By controlling the mixing ratio in the mixed enamel composition, at least one of the optical, thermal and chemical properties of the resulting enamel is tailored depending on the needs of customer. In addition, the cost of starting material can be potentially lowered due to the reduced use of Bi and/or Zn.

In accordance with another aspect, method of forming an enamel on a substrate is provided. The method comprises providing an enamel composition on the substrate. The enamel composition can be a paste or an ink including glass frits according to embodiments of present subject matter. The enamel compositions include about 40-90 wt. % one or more glass frits and about 10-60 wt. % organic vehicle to be suitable for depositing the enamel compositions to a substrate. The enamel compositions are deposited on the substrate by screen printing, roll coating, spraying, curtain coating, spin coating and digital printing. The method further comprises firing the enamel compositions and the substrate at a temperature to adhere the enamel compositions to the substrate. The firing temperature ranges from about 500° C. and about 705° C.

To the accomplishment of the foregoing and related ends, the present subject matter, then, involves the features hereinafter fully described and particularly pointed out in the claims. The following description set forth in detail certain illustrative embodiments of the present subject matter. These embodiments are indicative, however, of but a few of the various ways in which the principles of the present subject matter may be employed. Other objects, advantages and novel features of the present subject matter will become apparent from the following detailed description of the present subject matter.

### DETAILED DESCRIPTION OF THE EMBODIMENTS

Traditionally, enamel compositions have included lead (Pb) for lowering the sintering temperature of the enamel composition. However, due to the environmental and health issues, use of Pb has been reduced or eliminated to comply with the environmental and health regulations. Bismuth (Bi) and zinc (Zn) can be initial replacements for Pb in the enamel compositions to fuse the enamel at low temperatures and partially crystallize at temperatures at which sections of glass are preheated preparatory to forming operations so not to stick to press or vacuum heads. Moreover, such enamel compositions are desired to have low or no Bi₂O₃ to limit the use of an expensive bismuth oxide.

The subject enamel compositions includes a glass frit. The glass frit contains low Bi₂O₃ (typically less than 20 wt. %, preferably less than 16 wt. %, or more preferably less than 12 wt. %) or no Bi₂O₃. The subject enamel compositions contains one or more transition metal oxides to produce colored enamel compositions. In one embodiment, the subject enamel compositions provide bismuth-free, chemically durable enamel frit compositions. In another embodiment, the subject enamel compositions provide low-bismuth, chemically durable enamel frit compositions. The enamel compositions possess great chemical and mechanical strength. By incorporating one or more transition element oxides in the low-bismuth or bismuth-free enamel composition, the enamel composition with low L-value can be achieved. In still another embodiment, the subject enamel compositions provide, after sintering, a reduced enamel density and/or reduced coefficient of thermal expansion (CTE).

One particular application for the subject enamel compositions is the formation of opaque, dark colored enamel bands on sections of automotive glass, such as windshields and side and rear windows. In addition to imparting an aesthetically appealing appearance to the section of the glass, these opaque, colored enamel bands preferably block the transmission of sunlight and thereby prevent the degradation of underlying adhesive by ultraviolet radiation. Moreover, these opaque colored enamel bands preferably conceal a section of the silver-containing buss bars and wiring connections of rear glass defrosting systems from view from the outside of the vehicle.

The subject enamel compositions and methods for forming the enamel can be advantageous in providing enamels with reduced manufacturing cost since the subject enamel compositions include reduced amount of bismuth, e.g. bismuth oxide. Therefore, the subject matter provides new and useful glass enamel compositions which exhibit various distinct advantages over the glass enamels including bismuth and/or zinc.

### Enamel Compositions

The components of the subject compositions, articles and methods are detailed herein below. Certain embodiments of the present subject matter are envisioned where at least some percentages, temperatures, times, and ranges of other values are preceded by the modifier “about.” All compositional percentages for enamels and glass frits disclosed herein are molar, and are given for a blend of precursors prior to firing unless described otherwise. For example, a frit composition refers to a blend of precursor materials prior to melting, which is subsequently melted and quenched to form a glass frit. In a similar manner, an enamel composition refers to a blend of precursor materials prior to firing, which is mixed with other solid and liquid components to form an enamel composition. Enamel compositional percentages are given in weight percent (wt. %). Details on each ingredient follow.

### Glass Frit Components

As used herein, the term ‘glass frit’ means pre-fused glass material which is typically produced by rapid solidification of molten material followed by grinding or milling to the desired powder size.

In one embodiment, the glass frits include Li₂O: typically 0.1-15 mol %, preferably 0.1-12.5 mol %, and more preferably 0.1-10 mol %, Na₂O+K₂O+Rb₂O+Cs₂O: typically 5-20 mol %; preferably 7-18 mol %; and more preferably 8-16 mol %; Bi₂O₃: typically 0-40 mol %; preferably 0.1-30 mol % and more preferably 0.1-20 mol %; transition metal oxides: typically 0.1-20 mol %; preferably 0.2-18 mol % and more preferably 0.5-16 mol %; B₂O₃+Al₂O₃: typically 1-45 mol %; preferably 2-40 mol % and more preferably 5-35 mol %; SiO₂+TiO₂: typically 20-80 mol %; preferably 22-75 mol % and more preferably 25-70 mol %; and F: typically 0-40 mol %; preferably 0-30 mol % and more preferably 0-25 mol %. Transition metal oxides (TMO) are one or more oxides selected from Fe₂O₃, MnO₂, Cr₂O₃, or Co₃O₄. Table 1 below shows glass frits useful in the practice of the present subject matter. All values in Table 1 are in mol %.

TABLE 1
Glass Frit Component Formulation Ranges

| | | | More |
|---|---|---|---|
| Component | Typical | Preferred | Preferred |
| Li₂O | 0.1-15 | 0.1-12.5 | 0.1-10 |
| Na₂O + K₂O + Rb₂O + Cs₂O | 5-20 | 7-18 | 8-16 |
| Bi₂O₃ | 0-40 | 0.1-30 | 0.1-20 |
| TMO | 0.1-20 | 0.2-18 | 0.5-16 |
| B₂O₃ + Al₂O₃ | 1-45 | 2-40 | 5-35 |
| SiO₂ + TiO₂ | 20-80 | 22-75 | 25-70 |
| F | 0-40 | 0-30 | 0-25 |

Combinations of ranges of oxides indicated hereinabove as “typical”, “preferred,” and “more preferred” in various combinations are available, so long as such combinations of ranges can add up to 100 mol %. For example, the glass frits include, prior to firing, about 0.1 to about 10 mol % of Li₂O, about 5 to about 20 mol % of Na₂O+K₂O+Rb₂O+Cs₂O, about 0.1 to about 30 mol % of Bi₂O₃, about 0.1 to about 20 mol % of transition metal oxides, about 1 to about 45 mol % of B₂O₃+Al₂O₃, about 20 to about 80 mol % of SiO₂+TiO₂, and 0 to about 40 mol % of F.

In another embodiment, the glass frits include Li₂O: typically 0.1-15 mol %, preferably 0.1-12.5 mol %, and more preferably 0.1-10 mol %, Na₂O+K₂O+Rb₂O+Cs₂O: typically 5-20 mol %, preferably 7-18 mol %, and more preferably 8-16 mol %; transition metal oxides: typically 0.1-20 mol %, preferably 0.2-18 mol %, and more preferably 0.5-16 mol %; B₂O₃+Al₂O₃: typically 1-45 mol %, preferably 2-40 mol %, and more preferably 5-35 mol %; SiO₂+TiO₂: typically 20-80 mol %, preferably 22-75 mol %, and more preferably 25-70 mol %; and F: typically 0-40 mol %, preferably 0-30 mol %, and more preferably 0-25 mol %. The glass frit is devoid of least one of Bi and Zn. Alternately, the glass frit does not include Bi and Zn. Table 2 below shows glass frits useful in the practice of the present subject matter. All values in Table 2 are in mol %.

TABLE 2
Glass Frit Component Formulation Ranges

| | | | More |
|---|---|---|---|
| Component | Typical | Preferred | Preferred |
| Li₂O | 0.1-15 | 0.1-12.5 | 0.1-10 |
| Na₂O + K₂O + Rb₂O + Cs₂O | 5-20 | 7-18 | 8-16 |
| TMO | 0.1-20 | 0.2-18 | 0.5-16 |
| B₂O₃ + Al₂O₃ | 1-45 | 2-40 | 5-35 |
| SiO₂ + TiO₂ | 20-80 | 22-75 | 25-70 |
| F | 0-40 | 0-30 | 0-25 |

In yet another embodiment, the glass frits include Li₂O: typically 0.1-15 mol %, preferably 0.1-12.5 mol %, and more preferably 0.1-10 mol %, Na₂O+K₂O+Rb₂O+Cs₂O: typically 5-20 mol %, preferably 7-18 mol %, and more preferably 8-16 mol %; Bi₂O₃: typically 0-40 mol %, preferably 0.1-30 mol %, and more preferably 0.1-20 mol %; transition metal oxides: typically 0.1-20 mol %, preferably 0.2-18 mol %, and more preferably 0.5-16 mol %; B₂O₃+Al₂O₃: typically 1-45 mol %, preferably 2-40 mol %, and more preferably 5-35 mol %; SiO₂+TiO₂: typically 20-80 mol %, preferably 22-75 mol %, and more preferably 25-70 mol %; main group oxides; typically 0.1-20 mol %, preferably 0.2-15 mol %, and more preferably 0.3-10 mol %; and F: typically 0-40 mol %, preferably 0-30 mol %, and more preferably 0-25 mol %. Main group oxides are selected from the group consisting of Ga₂O₃, In₂O₃, GeO₂, SnO₂, P₂O₅, Sb₂O₃, SO₃, SeO₂, TeO₂, Tl₂O, Pb₃O₄ and As₂O₅. The main group oxides do not include B, Al, Si, and Bi. Table 3 below shows glass frits useful in the practice of the present subject matter. All values in Table 3 are in mol %.

TABLE 3
Glass Frit Component Formulation Ranges

| | | | More |
|---|---|---|---|
| Component | Typical | Preferred | Preferred |
| Li₂O | 0.1-15 | 0.1-12.5 | 0.1-10 |
| Na₂O + K₂O + Rb₂O + Cs₂O | 5-20 | 7-18 | 8-16 |
| Bi₂O₃ | 0-40 | 0.1-30 | 0.1-20 |
| TMO | 0.1-20 | 0.2-18 | 0.5-16 |
| B₂O₃ + Al₂O₃ | 1-45 | 2-40 | 5-35 |
| SiO₂ + TiO₂ | 20-80 | 22-75 | 25-70 |
| Main group oxides | 0.1-20 | 0.2-15 | 0.3-10 |
| F | 0-40 | 0-30 | 0-25 |

In still yet another embodiment, the glass frits include Li₂O: typically 0.1-15 mol %, preferably 0.1-12.5 mol %, and more preferably 0.1-10 mol %, Na₂O+K₂O+Rb₂O+Cs₂O: typically 5-20 mol %; preferably 7-18 mol %; and more preferably 8-16 mol %; transition metal oxides: typically 0.1-20 mol %; preferably 0.2-18 mol % and more preferably 0.5-16 mol %; B₂O₃+Al₂O₃: typically 1-45 mol %; preferably 2-40 mol % and more preferably 5-35 mol %; SiO₂+TiO₂: typically 20-80 mol %; preferably 22-75 mol % and more preferably 25-70 mol %; main group oxides; typically 0.1-20 mol %, preferably 0.2-15 mol %, more preferably 0.3-10 mol %; and F: typically 0-40 mol %; preferably 0-30 mol % and more preferably 0-25 mol %. Main group oxides are selected from the group consisting of Ga₂O₃, In₂O₃, GeO₂, SnO₂, P₂O₅, Sb₂O₃, SO₃, SeO₂, TeO₂, Tl₂O, Pb₃O₄ and As₂O₅. The main group oxides do not include B, Al, Si, and Bi. The glass frit is devoid of at least one of Bi and Zn. Alternately, the glass frit is devoid of both Bi and Zn. Table 4 below shows glass frits useful in the practice of the present subject matter. All values in Table 4 are in mol %.

TABLE 4
Glass Frit Component Formulation Ranges

| | | | More |
|---|---|---|---|
| Component | Typical | Preferred | Preferred |
| Li₂O | 0.1-15 | 0.1-12.5 | 0.1-10 |
| Na₂O + K₂O + Rb₂O + Cs₂O | 5-20 | 7-18 | 8-16 |
| TMO | 0.1-20 | 0.2-18 | 0.5-16 |
| B₂O₃ + Al₂O₃ | 1-45 | 2-40 | 5-35 |
| SiO₂ + TiO₂ | 20-80 | 22-75 | 25-70 |
| Main group oxides | 0.1-20 | 0.2-15 | 0.3-10 |
| F | 0-40 | 0-30 | 0-25 |

The present subject matter also includes the additions of anions (preferentially F, S and Se) to oxygen sites in the glass frits to modulate frit and enamel properties, such as fluxing the dissolution of oxide raw materials and the chemical trapping of migrating silver ions.

Throughout the specification and claims, in all cases, for all tables and for all embodiments, when a range is indicated as being bounded by zero on the lower end, or a component is indicated as being included “up to” or “s” a specified mole %, these provides support for the same range bounded by 0.01 or 0.1 at the lower end, or a component being included from 0.01 or 0.1 mole % up to the specified upper limit for mole %. In a recitation of a group of ingredients, such as “up to 25 mole % Na₂O+K₂O+Rb₂O+Cs₂O,” the recitation also provides support for 0.01-25 mol % or 0.1-25 mol % of the recited group of ingredients as well as such ranges of each individual ingredient in the group (e.g., 0.01-25 mol % Na₂O or 0.1-25 mol % K₂O) and any combination thereof. Further, 0-40 mol % F also supports 0.01-40 mol % F or 0.1-40 mol % F.

In one embodiment, the glass frit includes, about 1 to about 10 mol % Li₂O, about 3 to about 15 mol % Na₂O, about 20 to about 65 mol % SiO₂, about 1 to about 40 mol % B₂O₃, about 0.1 to about 3 mol % Al₂O₃, about 0.1 to about 16 mol % TiO₂, about 2.3 to about 17.8 mol % Fe₂O₃, about 2.2 to about 6.1 mol % MnO₂, and about 1.2 to about 2.4 mol % Co₃O₄.

In another embodiment, the glass frit includes, about 1 to about 10 mol % Li₂O, about 4 to about 15 mol % Na₂O, about 20 to about 65 mol % SiO₂, about 3 to about 40 mol % B₂O₃, about 0.1 to about 3 mol % Al₂O₃, about 0.1 to about 14 mol % TiO₂, about 3.3 to about 17.8 mol % Fe₂O₃, about 2.2 to about 4.2 mol % MnO₂, and about 1.2 to about 2.4 mol % Co₃O₄. The glass frit is devoid of at least one of Bi and Zn. Alternately, the glass frit is devoid of both Bi and Zn.

In yet another embodiment, the glass frit includes, about 5 to about 7 mol % Li₂O, about 6 to about 10 mol % Na₂O, about 34 to about 51 mol % SiO₂, about 24 to about 33 mol % B₂O₃, about 0.65 to about 1 mol % Al₂O₃, about 1.5 to about 2.1 mol % TiO₂, about 3.5 to about 14.5 mol % Fe₂O₃, about 2.3 to about 3.3 mol % MnO₂, and about 1.35 to about 1.85 mol % Co₃O₄. The glass frit is devoid of at least one of Bi and Zn. Alternately, the glass frit is devoid of both Bi and Zn.

In still yet another embodiment, the glass frit includes, about 6 to about 9 mol % Li₂O, about 8 to about 12 mol % Na₂O, about 43 to about 62 mol % SiO₂, about 9 to about 14 mol % B₂O₃, about 0.8 to about 1.3 mol % Al₂O₃, about 1.8 to about 2.7 mol % TiO₂, about 4 to about 17.8 mol % Fe₂O₃, about 2.8 to about 4.2 mol % MnO₂, and about 1.6 to about 2.4 mol % Co₃O₄. The glass frit is devoid of at least one of Bi and Zn. Alternately, the glass frit is devoid of both Bi and Zn.

In yet another embodiment, the glass frit includes, about 4 to about 7 mol % Li₂O, about 6 to about 8.5 mol % Na₂O, about 31 to about 46 mol % SiO₂, about 22 to about 30 mol % B₂O₃, about 0.6 to about 0.9 mol % Al₂O₃, about 9 to about 12 mol % TiO₂, about 3 to about 13 mol % Fe₂O₃, about 2.2 to about 3 mol % MnO₂, and about 1.2 to about 1.7 mol % Co₃O₄. The glass frit is devoid of at least one of Bi and Zn. Alternately, the glass frit is devoid of both Bi and Zn.

In still yet another embodiment, the glass frit includes, about 5 to about 8 mol % Li₂O, about 7 to about 10.5 mol % Na₂O, about 38 to about 56 mol % SiO₂, about 8 to about 12 mol % B₂O₃, about 0.7 to about 1.1 mol % Al₂O₃, about 10.5 to about 15 mol % TiO₂, about 4 to about 12.5 mol % Fe₂O₃, about 2.5 to about 3.7 mol % MnO₂, and about 1.4 to about 2.1 mol % Co₃O₄. The glass frit is devoid of at least one of Bi and Zn. Alternately, the glass frit is devoid of Bi and Zn.

In one embodiment, the glass frit includes, about 5 to about 10 mol % Li₂O, about 3 to about 7 mol % Na₂O, about 30 to about 55 mol % SiO₂, about 1 to about 15 mol % B₂O₃, about 0.1 to about 2 mol % Al₂O₃, about 0 to about 15 mol % ZnO, about 10 to about 20 mol % Bi₂O₃, about 1 to about 16 mol % TiO₂, about 4.7 to about 6.1 mol % MnO₂, about 2.3 to about 11.8 mol % Fe₂O₃, and about 1.5 to about 2.1 mol % Co₃O₄.

In another embodiment, the glass frit includes, about 7 to about 9 mol % Li₂O, about 4 to about 6 mol % Na₂O, about 40 to about 45 mol % SiO₂, about 2 to about 5 mol % B₂O₃, about 0.9 to about 1.2 mol % Al₂O₃, about 14 to about 17 mol % Bi₂O₃, about 4 to about 9.5 mol % TiO₂, about 4.8 to about 5.8 mol % MnO₂, about 2.3 to about 7.7 mol % Fe₂O₃, and about 1.6 to about 2 mol % Co₃O₄.

In yet another embodiment, the glass frit includes, about 7.2 to about 7.5 mol % Li₂O, about 4.7 to about 5 mol % Na₂O, about 38 to about 40 mol % SiO₂, about 4 to about 12 mol % B₂O₃, about 0.9 to about 1.1 mol % Al₂O₃, about 14.8 to about 15.5 mol % Bi₂O₃, about 8 to about 14 mol % TiO₂, about 5 to about 5.3 mol % MnO₂, about 6.6 to about 7 mol % Fe₂O₃, and about 1.6 to about 1.8 mol % Co₃O₄.

In still yet another embodiment, the glass frit includes, about 6.9 to about 7.5 mol % Li₂O, about 4.5 to about 5 mol % Na₂O, about 37 to about 40 mol % SiO₂, about 4 to about 4.5 mol % B₂O₃, about 0.9 to about 1.1 mol % Al₂O₃, about 3.7 to about 10.8 mol % ZnO, about 14 to about 16 mol % Bi₂O₃, about 8 to about 9 mol % TiO₂, about 4.5 to about 5.5 mol % MnO₂, about 6.3 to about 7.1 mol % Fe₂O₃, and about 1.6 to about 1.8 mol % Co₃O₄.

In yet another embodiment, the glass frit includes, about 7.3 to about 8.7 mol % Li₂O, about 4.8 to about 5.8 mol % Na₂O, about 35 to about 40 mol % SiO₂, about 4.3 to about 5.2 mol % B₂O₃, about 1 to about 1.2 mol % Al₂O₃, about 15 to about 18 mol % Bi₂O₃, about 8.5 to about 10.5 mol % TiO₂, about 5 to about 6.2 mol % MnO₂, about 8 to about 12 mol % Fe₂O₃, and about 1.7 to about 2.1 mol % Co₃O₄.

In order to get desired properties such as low firing temperature, chemical durability, reasonable density, improved mechanical strength, low L-value, and reasonable thermal expansion, the compositional range of individual oxides of present inventive frits should be in the above mentioned ranges.

In one embodiment, the glass frits are substantially devoid of at least one of the elements selected from the group consisting of lead, bismuth, and zinc. For example, the glass frits (for example, Table 2) are substantially devoid of lead, bismuth, and zinc. In another embodiment, the glass frits are substantially devoid of lead and bismuth, but the glass frits include zinc. In yet another embodiment, the glass frits are substantially devoid of lead and zinc, but the glass frits include bismuth. As used herein, “substantially free of an element”, or “substantially devoid of an element” means that the glass frits do not include the element in any form, or the element or any compounds that contain the element are not intentionally added to the glass frits. For example, in some embodiments, all the materials used in forming the glass frits are substantially devoid of at least one of the elements selected from the group consisting of lead, bismuth, and zinc. In another embodiment, a method of making the glass frits does not involve combining at least one of the elements selected from the group consisting of lead, bismuth, and zinc with the glass frits and/or precursor materials of the glass frits.

The enamel compositions can include any suitable amount of the glass frit. In one embodiment, the solid portions of the enamel compositions include from about 55 to about 99 wt. % of the glass frit. In another embodiment, the enamel compositions include from about 57.5 to about 98.5 wt. % of the glass frit. In yet another embodiment, the enamel compositions include about 60 to about 98 wt. % of the glass frit.

### Organic Vehicle

The glass frits and enamel compositions can be combined with an organic vehicle. The glass frits can be combined with the vehicle to form a printable enamel paste. The vehicle to be employed in the paste can be selected on the basis of its end use application. In one embodiment, the vehicle adequately suspends the particulates and burns off completely upon firing of the paste on the substrate. Vehicles are typically organic. Examples of organic vehicles include compositions based on pine oils, alcohols of various chain lengths, glycols, glycol ethers, vegetable oils, mineral oils, low molecular weight petroleum fractions, synthetic and natural resins, and the like. In another embodiment, surfactants and/or other film forming modifiers can also be included.

The specific vehicle and amounts employed are selected based upon the specific components of the paste and the desired viscosity. The enamel paste in general can contain from about 30 to about 90 wt. % solids as above described, more preferably about 35 to about 88 wt. % solids, and about 10 to about 70 wt. % of the suitable organic vehicle, more preferably about 12 to about 65 wt. %. In another example, the enamel paste can include from about 40 to about 90 wt. % solids as above described, and about 10 to about 60 wt. % of the suitable organic vehicle.

The viscosity of the paste can be adjusted depending on application techniques on a substrate such as screen printing, roll coating, spraying, curtain coating, spin coating, and digital coating. The vehicles can be modified by viscous resins such as vinyl resins, solvents, film formers such as cellulosic materials, and the like. For purposes of screen-printing, viscosities ranging from 10,000 to 80,000 and preferably 35,000 to 65,000 centipoises at 20° C., as determined on a Brookfield Viscometer, #7 spindle at 20 rpm, are appropriate.

### Other Components

In certain embodiments, the enamel compositions optionally further include a reducing agent, dispersing surfactant, rheological modifier, flow aid, adhesion promoter, CTE modifier, or silver (Ag) hiding component.

### Substrate

The present subject matter can provide a substrate having fired thereon an enamel compositions (e.g., enamel paste) of the present subject matter. Any suitable substrate can be used in the subject present subject matter. Examples of substrates include glass, ceramic or other non-porous substrates. Specific examples of substrates include an automotive glass substrate, architectural glass, appliance glass, beverage containers and technical glasses such as Borofloat 33, Eagle XG, fused silica and the like.

### Method of Forming Enamel on Substrate for Automotive Application

To prepare the enamel compositions of the present subject matter, the glass frits are produced by mixing together glass frit compositions disclosed in Tables 1-4 and further described in the present specification. The mixed raw batch compositions are melted at temperatures between 1350° C. to 1475° C. for about 45-90 minutes, followed by sudden cooling, for example, using water or air quenching, or other methods known to those skilled in the art. The resulting glass frits are then ground to a fine particle size from about 1 to about 8 micron, preferably between 2 to 6 microns using a ball mill, more preferably about 3 to about 5 microns. The finely ground powder frits are then used to form glass enamel compositions. The frit component is then combined with the other solids components. The solids are then mixed with the necessary vehicle to form the enamel paste or enamel ink. The viscosity is adjusted as desired.

Once the enamel paste is prepared, it can be applied to the substrate by any suitable technique. The enamel paste can be applied by screen printing, decal application, spraying, brushing, roll coating, curtain coating, digital printing or the like. Screen printing can be preferred when the paste is applied to a glass substrate.

After application of the paste to a substrate in a desired pattern, the applied coating is then fired to adhere the enamel to the substrate. The firing temperature is generally determined by the frit maturing temperature, and preferably is in a broad temperature range. In one aspect, the method of forming an enamel composition optionally further involves combining pigments, reducing agent, dispersing surfactant, rheological modifier, silver hiding component or CTE modifier. In this aspect, the enamel composition is lead-free and/or cadmium-free. Typically, the firing range is in the range of about 500° C. to about 735° C., more preferably in the range of about 510° C. to about 730° C., and most preferably about 520° C. to about 725° C. In another embodiment, the firing range is from about 540° C. to about 705° C.

A glass substrate can be colored and/or decorated by applying any enamel composition described herein to at least a portion of a substrate, for example, a glass substrate such as a glass sheet, or automotive glass, (e.g., windshield). An enamel composition can be applied in the form of a paste as disclosed herein.

The enamel composition is applied to the entire surface of a substrate, or to only a portion thereof, for example the periphery. The method involves forming a glass whereby the glass substrate is heated to an elevated temperature and subjected to a forming pressure to bend the glass substrate. In particular, bending the glass substrate involves heating the glass substrate to an elevated temperature of, for example, at least about 570° C., at least about 600° C., at least about 625° C., or at least about 700° C. Upon heating, the glass is subjected to a forming pressure, e.g., gravity sag or press bending in the range of about 0.1 to about 5 psi, or about 1 to about 4 psi, or typically about 2 to about 3 psi, with a forming die.

In another aspect, the enamel is printed onto the glass and the glass is dried to remove printing solvent. Next, a conductive paste is printed onto the glass, forming the de-frost grid or an antenna. After printing, the conductive paste, the glass is then fired and formed as described above.

### EXAMPLES

The following examples are provided to generally illustrate various embodiments in accordance with the present subject matter, and should not be construed to limit the present subject matter.

The following compositions represent exemplary embodiments of the present subject matter. They are presented to explain the present subject matter in more detail, and do not limit the present subject matter. Compositions of glass frits according to the present subject matter are given in Tables 5, 7, and 9. The results of the following investigations are exhibited in Tables 6, 8, and 9.

The glass frits are produced by mixing together raw materials as shown in Tables 1-4 and further described in the present specification. The mixed raw batch compositions are melted at temperatures between 1350° C. to 1475° C. for about 45-90 minutes, followed by sudden cooling, for example, using water or air quenching, or other methods known to those skilled in the art. The resulting glass frits are then ground to a fine particle size, preferably between 2 to 6 microns using a ball mill. The finely ground powder frits are then used to form glass enamel compositions. The glass frits are also produced by mixing together raw materials as shown in Tables 5 and 7 using the substantially similar steps described above for the glass frits as shown in Tables 1-4.

Testing is performed by combining the glass frit or enamel composition with a liquid vehicle and screen printing the resulting dispersion onto a microscope slide or automotive glass substrate at a wet thickness of 2 mils. The slides or automotive glass substrate are then fired at various temperatures to determine the “firing temperature,” FT, or “minimum firing temperature,” MF. The FT is the temperature where the glass has sufficient time to flow and fuse within a 15 minute fire and yield a glossy smooth surface. The MF is the temperature where the enamel has sufficient time to flow and fuse in a 3 minute fire and yield an enamel without interconnected porosity. Preheat time is 10 minutes at 800° F. for FT and no preheat for MF.

The coefficient of thermal expansion (CTE) is determined from 100° C. to 300° C. using a dilatometer (1000R, Orton Ceramic, Westerville, Ohio, USA). The CTE is reported in the temperature range of 100° C. to 300° C. and has units of 10-7° C.⁻¹. Glass transition temperatures (T_{g}) and dilatometric softening temperatures (Tₛ) are also measured using the dilatometer.

Room temperature chemical durability is determined with an acid drop test using 1N H₂SO₄. The acid resistance is evaluated by utilizing a modified version of ASTM C724-91, which is incorporated herein by reference in its entirety. Fired trials are exposed to a drop of 1 N H₂SO₄ solution for 10 minutes at room temperature. They are graded according to the following scale:
Grade 1—No apparent attack,
Grade 2—Appearance of iridescence or visible stain on the exposed surface when viewed at an angle of 45°, but not apparent when viewed at angles less than 30°,
Grade 3—A definite stain which does not blur reflected images and is visible at angles less than 30°,
Grade 4—Definite stain with a gross color change or strongly iridescent surface visible at angles less than 30° and which may blur reflected images,
Grade 5—Surface dull or matte with chalking possible,
Grade 6—Significant removal of enamel with pin-holing evident,
Grade 7—Complete removal of enamel in exposed area.

The acid durability test using 0.1 N H₂SO₄ at 80° C. for different time intervals are conducted (this test is commonly called the “Toyota test”) and the color difference is measured according to the following procedure. The results are shown as “Acid hours” in Table 9. L-value is measured using Hunter L-value. The maximum for L is 100, which is a perfect reflecting diffuser, i.e., pure white. The minimum for L is zero, which is black.

Optical density is the logarithmic ratio of the intensity of transmitted light to the intensity of the incident light passing through the substance. It is otherwise measured as the absorbed radiation of the corresponding wavelength.

Frit density was measured based on the Archimedes method, where the weight of a frit chip and its volume displacement in water are determined.

In accordance with the present subject matter, Table 5 below provides a summary of a plurality of exemplary glass compositions 1-17, and lists for each glass composition, the mole % of various oxides prior to firing. The glass compositions 1-17 do not include lead (Pb), bismuth (Bi), and zinc (Zn). It is noted that values from different rows of Table 5 can be used to formulate a glass composition in accordance with the present subject matter.

TABLE 5
Mole % of Oxides for Glass frit Prior to Firing

| | Glass Composition | | | | | | | | |
|---|---|---|---|---|---|---|---|---|---|
| Example | Li₂O | Na₂O | SiO₂ | B₂O₃ | Al₂O₃ | TiO₂ | Fe₂O₃ | MnO₂ | Co₃O₄ |
| 1 | 4.72 | 6.28 | 42.29 | 22.58 | 0.65 | 9.13 | 10.87 | 2.22 | 1.26 |
| 2 | 5.11 | 6.81 | 45.81 | 24.47 | 0.71 | 1.54 | 11.78 | 2.40 | 1.37 |
| 3 | 5.57 | 7.43 | 31.81 | 26.69 | 0.77 | 10.77 | 12.85 | 2.62 | 1.49 |
| 4 | 6.13 | 8.17 | 34.99 | 29.36 | 0.85 | 1.85 | 14.13 | 2.88 | 1.64 |
| 5 | 5.11 | 6.81 | 45.81 | 24.47 | 0.71 | 9.88 | 3.44 | 2.40 | 1.37 |
| 6 | 5.57 | 7.43 | 50.00 | 26.69 | 0.77 | 1.68 | 3.75 | 2.62 | 1.49 |
| 7 | 6.13 | 8.17 | 34.99 | 29.36 | 0.85 | 11.85 | 4.13 | 2.88 | 1.64 |
| 8 | 6.81 | 9.08 | 38.88 | 32.62 | 0.94 | 2.06 | 4.59 | 3.20 | 1.82 |
| 9 | 6.13 | 8.17 | 44.99 | 19.36 | 0.85 | 6.85 | 9.13 | 2.88 | 1.64 |
| 10 | 5.57 | 7.43 | 49.99 | 8.51 | 0.77 | 10.77 | 12.85 | 2.62 | 1.49 |
| 11 | 6.13 | 8.17 | 54.99 | 9.36 | 0.85 | 1.85 | 14.13 | 2.88 | 1.64 |
| 12 | 6.81 | 9.08 | 38.88 | 10.40 | 0.94 | 13.17 | 15.70 | 3.20 | 1.82 |
| 13 | 7.66 | 10.21 | 43.75 | 11.70 | 1.06 | 2.31 | 17.66 | 3.60 | 2.05 |
| 14 | 6.13 | 8.17 | 54.99 | 9.36 | 0.85 | 11.85 | 4.13 | 2.88 | 1.64 |
| 15 | 6.81 | 9.08 | 61.10 | 10.40 | 0.94 | 2.06 | 4.59 | 3.20 | 1.82 |
| 16 | 7.66 | 10.21 | 43.75 | 11.70 | 1.06 | 14.81 | 5.16 | 3.60 | 2.05 |
| 17 | 8.76 | 11.67 | 50.00 | 13.37 | 1.21 | 2.64 | 5.90 | 4.11 | 2.34 |

The exemplary glass frit compositions 1-17 are ground to a fine powder using conventional techniques including milling. The frit composition is then optionally combined with the other solid components such as pigments. The solids are then mixed with the necessary vehicles to form the enamel paste or the ink. The viscosity is adjusted as desired.

The above identified Examples 1-17 are provided as models, and should not be construed to limit the present subject matter.

A number of properties of the exemplary glass frits 1-17 are analyzed (Table 6) after firing at the minimum firing temperature (MF) as indicated in Table 6. After firing, frit density, coefficient of thermal expansion (CTE), chemical stability for acid solution, optical property (L-value), and optical density are measured for glass frits 1-17. From Table 6, it is seen that glass frit examples 1-17 have properties that span from one end to the other end from one frit example to another frit example. For example, Example 2 exhibits the optical density of 1.74 and L-value of 5.59, while Example 6 exhibits smaller optical density (1.47) and greater L-value (11.61), compared to Example 2. Table 6 indicates that glass frit can be selected depending on the requirements of the customer application. For example, the customer can decide a glass frit with low GTE, or a glass frit with low L-value, or a glass frit with high chemical durability, depending on the application requirements.

TABLE 6
Properties of Glass frits After Firing

| | Min. | Frit | CTE | Acid | | |
|---|---|---|---|---|---|---|
| | Firing | Density | (×10⁻⁷/ | Drop | L- | Optical |
| Example | (° C.) | (g/cc) | ° C.) | (hrs) | value | density |
| 1 | 670 | 2.91 | 79.5 | 1 | 9.83 | 1.86 |
| 2 | 650 | 2.80 | 76.4 | 1 | 5.59 | 1.74 |
| 3 | 660 | 3.02 | 86.6 | 2 | 13.72 | 1.81 |
| 4 | 640 | 2.93 | 86.9 | 2 | 8.97 | 1.93 |
| 5 | 660 | 2.61 | 71.9 | 1 | 14.85 | 1.32 |
| 6 | 650 | 2.55 | 66.3 | 1 | 11.61 | 1.47 |
| 7 | 640 | 2.77 | 81.0 | 3 | 17.81 | 2.91 |
| 8 | 610 | 2.66 | 76.8 | 4 | 15.20 | 2.52 |
| 9 | 620 | 2.90 | 79.7 | 2 | 4.80 | 2.25 |
| 10 | 640 | 2.93 | 82.7 | 1 | 6.03 | 2.42 |
| 11 | 640 | 3.02 | 81.9 | 1 | 4.23 | 2.77 |
| 12 | 640 | 3.20 | 94.6 | 2 | 11.95 | 3.42 |
| 13 | 620 | 3.14 | 101.2 | 2 | 6.19 | 4.32 |
| 14 | 630 | 2.81 | 79.3 | 1 | 8.03 | 1.23 |
| 15 | 620 | 2.69 | 77.3 | 1 | 11.54 | 1.28 |
| 16 | 600 | 2.96 | 93.6 | 2 | 15.15 | 2.09 |
| 17 | 610 | 2.70 | 93.6 | 3 | 13.08 | 2.56 |

In accordance with the present subject matter, Table 7 below provides a summary of a plurality of exemplary glass compositions 18-29, and lists for each glass composition, the mole % of various oxides prior to firing. The glass compositions 18-29 do not include lead (Pb). It is noted that values from different rows of Table 7 can be used to formulate a glass composition in accordance with the present subject matter.

TABLE 7
Mole % of Oxides for Glass frits Prior to Firing

| | Glass Composition | | | | | | | | | | |
|---|---|---|---|---|---|---|---|---|---|---|---|
| Example | Li₂O | Na₂O | SiO₂ | B₂O₃ | Al₂O₃ | ZnO | Bi₂O₃ | TiO₂ | Fe₂O₃ | MnO₂ | Co₃O₄ |
| 18 | 7.06 | 4.67 | 46.84 | 4.22 | 0.96 | 0.00 | 14.63 | 8.41 | 4.95 | 6.61 | 1.65 |
| 19 | 8.63 | 5.71 | 35.00 | 5.16 | 1.18 | 0.00 | 17.88 | 10.28 | 6.06 | 8.08 | 2.02 |
| 20 | 7.19 | 4.76 | 38.44 | 11.70 | 0.98 | 0.00 | 14.90 | 8.56 | 5.05 | 6.73 | 1.69 |
| 21 | 7.93 | 5.24 | 42.36 | 2.69 | 1.08 | 0.00 | 16.42 | 9.44 | 5.56 | 7.42 | 1.86 |
| 22 | 7.40 | 4.90 | 39.54 | 4.42 | 1.01 | 0.00 | 15.32 | 13.57 | 5.19 | 6.92 | 1.73 |
| 23 | 8.18 | 5.41 | 43.69 | 4.88 | 1.12 | 0.00 | 16.94 | 4.47 | 5.74 | 7.65 | 1.92 |
| 24 | 7.77 | 5.14 | 41.51 | 4.64 | 1.06 | 0.00 | 16.09 | 9.25 | 5.45 | 7.27 | 1.82 |
| 25 | 7.47 | 4.94 | 39.92 | 4.46 | 1.02 | 3.85 | 15.47 | 8.89 | 5.24 | 6.99 | 1.75 |
| 26 | 7.19 | 4.76 | 38.43 | 4.30 | 0.98 | 7.41 | 14.90 | 8.56 | 5.05 | 6.73 | 1.69 |
| 27 | 6.94 | 4.59 | 37.05 | 4.14 | 0.95 | 10.71 | 14.37 | 8.26 | 4.87 | 6.49 | 1.63 |
| 28 | 7.40 | 4.90 | 39.53 | 4.42 | 1.01 | 0.00 | 15.32 | 8.81 | 5.19 | 11.69 | 1.73 |
| 29 | 8.18 | 5.41 | 43.68 | 4.88 | 1.12 | 0.00 | 16.94 | 9.74 | 5.74 | 2.39 | 1.92 |

The exemplary glass compositions 18-29 were ground to a find powder using conventional techniques including milling. The frit composition is then combined with the other solid components. The solids are then mixed with the necessary vehicles to form the enamel paste. The viscosity is adjusted as desired.

The above identified Examples 18-29 are provided as models, and should not be construed to limit the present subject matter.

A number of properties of the exemplary glass frits 18-29 were analyzed (Table 8) after firing at the minimum firing temperature (MF) as indicated in Table 8. After firing, a frit density, coefficient of thermal expansion (CTE), chemical stability for acid solution, optical property (L-value), and optical density were measured for each glass compositions 1-17. Examples 18-19 in Table 7 have minimum firing temperatures (MF) of about 540-570° C., which are lower than minimum firing temperatures (about 600-660° C.) of Examples 1-17. The lower minimum firing temperatures may be in part due to the presence of Bi and/or Zn in Examples 18-19.

TABLE 8
Properties of Glass frits After Firing

| | Min. | Frit | CTE | Acid | | |
|---|---|---|---|---|---|---|
| | Firing | Density | (×10⁻⁷/ | Drop | L- | Optical |
| Example | (° C.) | (g/cc) | ° C.) | (hrs) | value | density |
| 18 | 570 | 4.70 | 90.9 | 2 | 20.04 | 2.22 |
| 19 | 550 | 5.00 | 99.3 | 2 | 13.92 | 2.91 |
| 20 | 550 | 4.60 | 89.9 | 4 | 22.52 | 2.79 |
| 21 | 560 | 4.55 | 91.0 | 2 | 18.78 | 1.98 |
| 22 | 550 | 4.83 | 93.2 | 2 | 20.87 | 2.07 |
| 23 | 530 | 4.90 | 93.8 | 3 | 9.66 | 2.84 |
| 24 | 530 | 4.89 | 96.4 | 2 | 18.32 | 2.57 |
| 25 | 550 | 4.96 | 95.4 | 2 | 15.34 | 2.57 |
| 26 | 550 | 4.86 | 93.1 | 3 | 14.18 | 2.29 |
| 27 | 550 | 4.94 | 94.3 | 2 | 10.89 | 1.86 |
| 28 | 550 | 4.77 | 95.3 | 2 | 11.49 | 2.52 |
| 29 | 540 | 4.88 | 97.1 | 4 | 29.66 | 1.81 |

In accordance with the present subject matter, the enamel compositions can include two or more glass frits to form a mixed enamel composition. For example, a mixed enamel compositions can be prepared by combining a dark colored glass frit according to the embodiments of the present subject matter with one or more conventional, nearly colorless glass frits. The conventional glass frits can include Bi or Zn. The conventional glass frits generally do not include transition metal compounds, except for TiO₂ and ZrO₂. The dark colored frits and the conventional frits bearing Bi or Zn can have different chemical compositions from each other. These frits with different compositions are combined to control the thermal, optical, chemical, physical and mechanical properties of the enamels after the firing step for the benefit of end users. A black pigment was also added to the mixed enamel composition to further control the optical properties of the enamel after firing. For example, as shown in Table 9, the mixed enamel compositions according to the embodiments of the present subject matter may selectively include the followings:

(1) a first frit selected from a conventional Bi-including frit, and a conventional Zn-including frit (Bi-containing frit “A”, Zn-containing frit “B”, commercially available from Ferro Corporation, Independence, Ohio). The first frits do not include any transition metal oxides other than TiO₂ and ZrO₂.

(2) a second frit selected from Bi-free Examples (6, 9, 10, 11) and Bi-including Examples (19 and 24). The second frit exhibits dark color after firing.

(3) a black colored pigment (V-7707, commercially available from Ferro Corporation, Independence, Ohio). V-7707 was used as a standard black pigment to be added to the mixed enamel composition. The V-7707 is a copper-manganese-chromium based pigment.

(4) an organic vehicle (C92 Medium, commercially available from Ferro Corporation, Independence, Ohio).

The solid portions, i.e., the first frit, second frit, black colored pigment, of the enamel compositions are dispersed and suspended in an organic vehicle selected for the end use application to form the enamel paste. The organic vehicle can optionally further include solvents, resins and surfactants.

The mixed enamel compositions include: about 80 to about 95 wt. % glass frit. The glass frit includes: about 0 to about 85 wt. % conventional frits (first frits), and about 1 to about 95 wt. % dark colored frits (second frits). The mixed enamel composition further comprises about 1 to about 35 wt. % black pigment, and about 0 to about 30 wt. % inorganic filler according to the embodiments. Preferably, the mixed enamel compositions include: 0 to about 30 wt. % conventional frits (first frits), about 45 to about 95 wt. % dark colored frits (second frits) according to the present subject matter, about 5 to about 20 wt. % black pigment, and, about 0 to about 30 wt. % inorganic filler. More preferably, the glass frit comprises about 45 wt. % first glass frit, and about 45 wt. % second glass frit. In Table 9, Example 30 includes 80 mol % of first frit including Bi, 20 mol % of black pigment ‘V-7707’, and does not include any colored second glass frit. Example 30 was used as a comparative sample in Table 9.

Examples 31-35, and 37-42 in Table 9 require reduced amount of Bi or Zn in the mixed enamel composition compared to Example 30 since a portion of Bi-containing first frit of Example 30 is replaced by Bi-free second frit in Examples 31-35, and 37-42. Reduced consumption of Bi or Zn, in particular Bi, in the mixed enamel composition can be advantageous since the amount of costly Bi₂O₃ can be reduced.

Table 9 also shows that Examples 31, 33-35, and 37-42 also require reduced amount (5-10%) of black pigment ‘V-7707’ compared to the amount (20%) of black pigment in Example 30.

By changing the ratio between the first frit (conventional) and second frit (dark colored) in a mixed enamel composition, the resulting properties of mixed enamel compositions can be tailored. For example, Table 9 set forth the mixed enamel compositions having L-value ranging from about 2.66 and about 7.31, and optical density ranging from about 2.66 and about 3.54. Table 9 also exhibits acid hours ranging from less than 4 hours up to 88 hours.

It is noted that the mixed enamel compositions according to the present subject matter provide optical, thermal or chemical property that are substantially equivalent to or better than the Bi containing comparative frit, Example 30. For example, Bi-free Example 35 is resistant to the acid enough to withstand for 88 hours after firing, which is more than 37% improvement compared to 64 hours for the comparative frit, Example 30, including 80 mol % of Bi containing frit. In another example, Example 31 is Bi-free and includes reduced amount of V-7707, compared to comparative frit Example 30. After firing, Example 31 exhibits similar level (2.66) of L-value to L-value (2.14) of comparative frit, Example 30. Therefore, Example 31 can replace Example 30 in an application requiring low L-value while reducing the use Example 30 including costly B-containing material.

These and other results disclosed herein demonstrate the excellent performance characteristics of the glass frits and enamel compositions of the present subject matter for automotive application.

TABLE 9
Compositions and Properties of Mixed Enamel Compositions

| | Example No. | 30 | 31 | 32 | 33 | 34 | 35 | 37 | 38 | 39 | 40 | 41 | 42 |
|---|---|---|---|---|---|---|---|---|---|---|---|---|---|
| 2^{nd} | Ex. 6 | | | | | | | 45 | | | 45 | | |
| frit | (Bi-free) | | | | | | | | | | | | |
| | Ex. 9 | | 95 | 55 | | | | | 45 | | | 45 | |
| | (Bi-free) | | | | | | | | | | | | |
| | Ex. 10 | | | | 60 | | 60 | | | | | | |
| | (Bi-free) | | | | | | | | | | | | |
| | Ex. 11 | | | | | 60 | | | | 45 | | | 45 |
| | (Bi-free) | | | | | | | | | | | | |
| | Ex. 19 | | | | | | | 45 | 45 | 45 | 45 | | |
| | (Bi-included) | | | | | | | | | | | | |
| | Ex. 24 | | | | | | | | | | | 45 | 45 |
| | (Bi-included) | | | | | | | | | | | | |
| 1^{st} | Bi-containing | 80 | | 25 | 30 | 30 | | | | | | | |
| frit | frit ‘A’ | | | | | | | | | | | | |
| | Zn-containing | | | | | | 30 | | | | | | |
| | frit ‘B’ | | | | | | | | | | | | |

| | | | | | | | | | | | | |
|---|---|---|---|---|---|---|---|---|---|---|---|---|
| Black Pigment | 20 | 5 | 20 | 10 | 10 | 10 | 10 | 10 | 10 | 10 | 10 | 10 |
| (V-7707) | | | | | | | | | | | | |
| Firing Temp (° C.) | 615 | 660 | 675 | 690 | 675 | 690 | 660 | 660 | 675 | 660 | 660 | 660 |
| Acid hours | 64 | 64 | 34 | 64 | 64 | 88 | <4 | 4 | 10 | <4 | <4 | <4 |
| L-value | 2.14 | 2.66 | 3.96 | 5.47 | 3.91 | 5.82 | 6.93 | 7.31 | 5.51 | 6.92 | 7.01 | 4.86 |
| Optical density | 2.40 | 3.01 | 3.37 | 2.60 | 2.66 | 3.11 | 3.22 | 3.53 | 3.29 | 3.28 | 3.54 | 3.41 |

It will be understood that any one or more compositions of one embodiment described herein can be combined with one or more other compositions of another embodiment. Thus, the present subject matter includes any and all combinations of compositions of the embodiments described herein.

What has been described above includes examples of the present subject matter. It is, of course, not possible to describe every conceivable combination of components or methodologies for purposes of describing the present subject matter, but one of ordinary skill in the art may recognize that many further combinations and permutations of the present subject matter are possible. Accordingly, the present subject matter is intended to embrace all such alterations, modifications and variations that fall within the spirit and scope of the appended claims.

The present subject matter is further defined by the following items.

Item 1. An enamel composition comprising a glass frit, the glass frit comprising, prior to firing:

about 0.1 to about 15 mol % Li₂O,

about 5 to about 20 mol % Na₂O+K₂O+Rb₂O+Cs₂O,

about 0.1 to about 20 mol % of one or more transition metal oxides selected from the group consisting of Fe₂O₃, MnO₂, Cr₂O₃, and Co₃O₄,

about 1 to about 45 mol % B₂O₃+Al₂O₃,

about 20 to about 80 mol % SiO₂+TiO₂, and

about 0 to about 40 mol % F.

Item 2. The enamel composition of item 1, wherein the glass frit further comprising, prior to firing:

about 0.1 to about 40 mol % Bi₂O₃.

Item 3. The enamel composition of item 2, wherein the glass frit comprises:

about 0.1 to about 12.5 mol % Li₂O,

about 7 to about 18 mol % Na₂O+K₂O+Rb₂O+Cs₂O,

about 0.1 to about 30 mol % Bi₂O₃,

about 0.2 to about 18 mol % of one or more transition metal oxides selected from the group consisting of Fe₂O₃, MnO₂, Cr₂O₃, and Co₃O₄,

about 2 to about 40 mol % B₂O₃+Al₂O₃,

about 22 to about 75 mol % SiO₂+TiO₂, and

about 0 to about 30 mol % F.

Item 4. The enamel composition of item 2, wherein the glass frit comprises:

about 0.1 to about 10 mol % Li₂O,

about 8 to about 16 mol % Na₂O+K₂O+Rb₂O+Cs₂O,

about 0.1 to about 20 mol % Bi₂O₃,

about 0.5 to about 16 mol % of one or more transition metal oxides selected from the group consisting of Fe₂O₃, MnO₂, Cr₂O₃, and Co₃O₄,

about 5 to about 35 mol % B₂O₃+Al₂O₃,

about 25 to about 70 mol % SiO₂+TiO₂, and

about 0 to about 25 mol % F.

Item 5. The enamel composition of any of items 2-4, wherein the glass frit further comprises about 0.1 to about 20 mol % main group oxides selected from the group consisting of Ga₂O₃, In₂O₃, GeO₂, SnO₂, P₂O₅, Sb₂O₃, SO₃, SeO₂, TeO₂, Tl₂O, Pb₃O₄ and As₂O₅.

Item 6. The enamel composition of item 5, wherein the glass frit comprises about 0.2 to about 15 mol % main group oxides.

Item 7. The enamel composition of item 5, wherein the glass frit comprises about 0.3 to about 10 mol % main group oxides.

Item 8. The enamel composition of any of items 5-7, wherein the main group oxides are free of B, Al, Si, and Bi.

Item 9. The enamel composition of any of items 5-8, wherein the main group oxides are selected from the group consisting of TeO₂ and SO₃.

Item 10. The enamel composition of item 1, wherein the glass frit comprises:

about 0.1 to about 12.5 mol % Li₂O,

about 7 to about 18 mol % Na₂O+K₂O+Rb₂O+Cs₂O,

about 0.2 to about 18 mol % of one or more transition metal oxides selected from the group consisting of Fe₂O₃, MnO₂, Cr₂O₃, and Co₃O₄,

about 2 to about 40 mol % B₂O₃+Al₂O₃,

about 22 to about 75 mol % SiO₂+TiO₂, and

about 0 to about 30 mol % F.

Item 11. The enamel composition of item 1, wherein the glass frit comprises:

about 0.1 to about 10 mol % Li₂O,

about 8 to about 16 mol % Na₂O+K₂O+Rb₂O+Cs₂O,

about 0.5 to about 16 mol % of one or more transition metal oxides selected from the group consisting of Fe₂O₃, MnO₂, Cr₂O₃, and Co₃O₄,

about 5 to about 35 mol % B₂O₃+Al₂O₃,

about 25 to about 70 mol % SiO₂+TiO₂, and

about 0 to about 25 mol % F.

Item 12. The enamel composition of any of items 1, 10, and 11, further devoid of at least one of Bi and Zn.

Item 13. The enamel composition of any of items 1, 10, and 11, further devoid of Bi and Zn.

Item 14. The enamel composition of any of items 1, 10, and 11, wherein the glass frit further comprising about 0.1 to about 20 mol % main group oxides selected from the group consisting of Ga₂O₃, In₂O₃, GeO₂, SnO₂, P₂O₅, Sb₂O₃, SO₃, SeO₂, TeO₂, Tl₂O, Pb₃O₄ and As₂O₅.

Item 15. The enamel composition of item 14, wherein the glass frit comprises about 0.2 to about 15 mol % main group oxides.

Item 16. The enamel composition of item 14, wherein the glass frit comprises about 0.3 to about 10 mol % main group oxides.

Item 17. A mixed enamel composition comprising a solid portion, the solid portion comprising, prior to firing:

about 80 to about 95 wt. % glass component comprising:
about 0 to about 85 wt. % first glass frit, and
about 1 to about 95 wt. % second glass frit, and

about 1 to about 35 wt. % pigment, and

about 0 to about 30 wt. % inorganic filler,

wherein the first glass frit includes at least one of Bi and Zn, the second glass frit is devoid of Bi and Zn, and the first glass frit has different color from the second glass frit.

Item 18. The mixed enamel composition of item 17, wherein the glass frit comprises:

about 0 to about 30 wt. % the first glass frit, and

about 45 to about 95 wt. % the second glass frit,

wherein the pigment ranges from about 5 to about 20 wt. %.

Item 19. The mixed enamel composition of item 17, wherein the glass frit comprises:

about 45 wt. % the first glass frit, and

about 45 wt. % the second glass frit.

Item 20. The mixed enamel composition of any of items 17-19, wherein an amount of Bi in the first glass frit is less than an amount of Bi in the second glass frit.

Item 21. The mixed enamel composition of any of items 17-20 further comprising a medium.

Item 22. The mixed enamel composition of any of items 17-21, after firing, exhibits an acid durability of about 4 to about 88 hours.

Item 23. The mixed enamel composition of any of items 17-21, after firing, exhibits L value of about 2.66 to about 7.31.

Item 24. The mixed enamel composition of any of items 17-21, after firing, exhibits an optical density ranging from about 2.60 and about 3.54.

Item 25. A glass frit comprising, prior to firing:

about 1 to about 10 mol % Li₂O,

about 3 to about 15 mol % Na₂O,

about 20 to about 65 mol % SiO₂,

about 1 to about 40 mol % B₂O₃,

about 0.1 to about 3 mol % Al₂O₃,

about 0.1 to about 16 mol % TiO₂,

about 2.3 to about 17.8 mol % Fe₂O₃,

about 2.2 to about 6.1 mol % MnO₂, and

about 1.2 to about 2.4 mol % Co₃O₄.

Item 26. The glass frit composition of item 25, comprising, prior to firing:

about 4 to about 15 mol % Na₂O,

about 3 to about 40 mol % B₂O₃,

about 0.1 to about 14 mol % TiO₂,

about 3.3 to about 17.8 mol % Fe₂O₃, and

about 2.2 to about 4.2 mol % MnO₂,

wherein the glass frit is devoid of at least one of Bi and Zn.

Item 27. The glass frit composition of item 26, comprising, prior to firing:

about 5 to about 7 mol % Li₂O,

about 6 to about 10 mol % Na₂O,

about 34 to about 51 mol % SiO₂,

about 24 to about 33 mol % B₂O₃,

about 0.65 to about 1 mol % Al₂O₃,

about 1.5 to about 2.1 mol % TiO₂,

about 3.5 to about 14.5 mol % Fe₂O₃,

about 2.3 to about 3.3 mol % MnO₂, and

about 1.35 to about 1.85 mol % Co₃O₄.

Item 28. The glass frit composition of item 26, comprising, prior to firing:

about 6 to about 9 mol % Li₂O,

about 8 to about 12 mol % Na₂O,

about 43 to about 62 mol % SiO₂,

about 9 to about 14 mol % B₂O₃,

about 0.8 to about 1.3 mol % Al₂O₃,

about 1.8 to about 2.7 mol % TiO₂,

about 4 to about 17.8 mol % Fe₂O₃,

about 2.8 to about 4.2 mol % MnO₂, and

about 1.6 to about 2.4 mol % Co₃O₄.

Item 29. The glass frit composition of item 26, comprising, prior to firing:

about 4 to about 7 mol % Li₂O,

about 6 to about 8.5 mol % Na₂O,

about 31 to about 46 mol % SiO₂,

about 22 to about 30 mol % B₂O₃,

about 0.6 to about 0.9 mol % Al₂O₃,

about 9 to about 12 mol % TiO₂,

about 3 to about 13 mol % Fe₂O₃,

about 2.2 to about 3 mol % MnO₂, and

about 1.2 to about 1.7 mol % Co₃O₄.

Item 30. The glass frit composition of item 26, comprising, prior to firing:

about 5 to about 8 mol % Li₂O,

about 7 to about 10.5 mol % Na₂O,

about 38 to about 56 mol % SiO₂,

about 8 to about 12 mol % B₂O₃,

about 0.7 to about 1.1 mol % Al₂O₃,

about 10.5 to about 15 mol % TiO₂,

about 4 to about 12.5 mol % Fe₂O₃,

about 2.5 to about 3.7 mol % MnO₂, and

about 1.4 to about 2.1 mol % Co₃O₄.

Item 31. The glass frit composition of item 25, comprising, prior to firing:

about 5 to about 10 mol % Li₂O,

about 3 to about 7 mol % Na₂O,

about 30 to about 55 mol % SiO₂,

about 1 to about 15 mol % B₂O₃,

about 0.1 to about 2 mol % Al₂O₃,

about 1 to about 16 mol % TiO₂,

about 4.7 to about 6.1 mol % MnO₂,

about 2.3 to about 11.8 mol % Fe₂O₃, and

about 1.5 to about 2.1 mol % Co₃O₄, and further comprising:

about 0 to about 15 mol % ZnO, and

about 10 to about 20 mol % Bi₂O₃.

Item 32. The glass frit composition of item 31, comprising, prior to firing:

about 7 to about 9 mol % Li₂O,

about 4 to about 6 mol % Na₂O,

about 40 to about 45 mol % SiO₂,

about 2 to about 5 mol % B₂O₃,

about 0.9 to about 1.2 mol % Al₂O₃,

about 14 to about 17 mol % Bi₂O₃,

about 4 to about 9.5 mol % TiO₂,

about 4.8 to about 5.8 mol % MnO₂,

about 2.3 to about 7.7 mol % Fe₂O₃, and

about 1.6 to about 2 mol % Co₃O₄.

Item 33. The glass frit composition of item 31, comprising, prior to firing:

about 7.2 to about 7.5 mol % Li₂O,

about 4.7 to about 5 mol % Na₂O,

about 38 to about 40 mol % SiO₂,

about 4 to about 12 mol % B₂O₃,

about 0.9 to about 1.1 mol % Al₂O₃,

about 14.8 to about 15.5 mol % Bi₂O₃,

about 8 to about 14 mol % TiO₂,

about 5 to about 5.3 mol % MnO₂,

about 6.6 to about 7 mol % Fe₂O₃, and

about 1.6 to about 1.8 mol % Co₃O₄.

Item 34. The glass frit composition of item 31, comprising, prior to firing:

about 6.9 to about 7.5 mol % Li₂O,

about 4.5 to about 5 mol % Na₂O,

about 37 to about 40 mol % SiO₂,

about 4 to about 4.5 mol % B₂O₃,

about 0.9 to about 1.1 mol % Al₂O₃,

about 3.7 to about 10.8 mol % ZnO,

about 14 to about 16 mol % Bi₂O₃,

about 8 to about 9 mol % TiO₂,

about 4.5 to about 5.5 mol % MnO₂,

about 6.3 to about 7.1 mol % Fe₂O₃, and

about 1.6 to about 1.8 mol % Co₃O₄.

Item 35. The glass frit composition of item 31, comprising, prior to firing:

about 7.3 to about 8.7 mol % Li₂O,

about 4.8 to about 5.8 mol % Na₂O,

about 35 to about 40 mol % SiO₂,

about 4.3 to about 5.2 mol % B₂O₃,

about 1 to about 1.2 mol % Al₂O₃,

about 15 to about 18 mol % Bi₂O₃,

about 8.5 to about 10.5 mol % TiO₂,

about 5 to about 6.2 mol % MnO₂,

about 8 to about 12 mol % Fe₂O₃, and

about 1.7 to about 2.1 mol % Co₃O₄.

Item 36. A method of decorating a substrate, comprising:

providing an enamel composition comprising the glass frit of any of items 25-35 on the substrate, and

firing the enamel composition and the substrate at a temperature to adhere the enamel composition to the substrate,

wherein the temperature ranges from about 500° C. to about 705° C.

1-12. (canceled)

13: A glass frit composition comprising:
about 1 to about 10 mol % Li₂O,
about 3 to about 15 mol % Na₂O,
about 20 to about 65 mol % SiO₂,
about 1 to about 40 mol % B₂O₃,
about 0.1 to about 3 mol % Al₂O₃,
about 0.1 to about 16 mol % TiO₂,
about 2.3 to about 17.8 mol % Fe₂O₃,
about 2.2 to about 6.1 mol % MnO₂, and
about 1.2 to about 2.4 mol % Co₃O₄.

14: The glass frit composition of claim 13, comprising,
about 1 to about 10 mol % Li₂O,
about 4 to about 15 mol % Na₂O,
about 20 to about 65 mol % SiO₂,
about 3 to about 40 mol % B₂O₃,
about 0.1 to about 3 mol % Al₂O₃,
about 0.1 to about 14 mol % TiO₂,
about 3.3 to about 17.8 mol % Fe₂O₃,
about 2.2 to about 4.2 mol % MnO₂, and
about 1.2 to about 2.4 mol % Co₃O₄,
wherein the glass frit is devoid of at least one of Bi and Zn.

15: The glass frit composition of claim 14, comprising:
about 5 to about 7 mol % Li₂O,
about 6 to about 10 mol % Na₂O,
about 34 to about 51 mol % SiO₂,
about 24 to about 33 mol % B₂O₃,
about 0.65 to about 1 mol % Al₂O₃,
about 1.5 to about 2.1 mol % TiO₂,
about 3.5 to about 14.5 mol % Fe₂O₃,
about 2.3 to about 3.3 mol % MnO₂, and
about 1.35 to about 1.85 mol % Co₃O₄.

16: The glass frit composition of claim 15, comprising:
about 6 to about 9 mol % Li₂O,
about 8 to about 12 mol % Na₂O,
about 43 to about 62 mol % SiO₂,
about 9 to about 14 mol % B₂O₃,
about 0.8 to about 1.3 mol % Al₂O₃,
about 1.8 to about 2.7 mol % TiO₂,
about 4 to about 17.8 mol % Fe₂O₃,
about 2.8 to about 4.2 mol % MnO₂, and
about 1.6 to about 2.4 mol % Co₃O₄.

17: The glass frit composition of claim 15, comprising:
about 5 to about 8 mol % Li₂O,
about 7 to about 10.5 mol % Na₂O,
about 38 to about 56 mol % SiO₂,
about 8 to about 12 mol % B₂O₃,
about 0.7 to about 1.1 mol % Al₂O₃,
about 10.5 to about 15 mol % TiO₂,
about 4 to about 12.5 mol % Fe₂O₃,
about 2.5 to about 3.7 mol % MnO₂, and
about 1.4 to about 2.1 mol % Co₃O₄.

18: The glass frit composition of claim 16, comprising:
about 4 to about 7 mol % Li₂O,
about 6 to about 8.5 mol % Na₂O,
about 31 to about 46 mol % SiO₂,
about 22 to about 30 mol % B₂O₃,
about 0.6 to about 0.9 mol % Al₂O₃,
about 9 to about 12 mol % TiO₂,
about 3 to about 13 mol % Fe₂O₃,
about 2.2 to about 3 mol % MnO₂, and
about 1.2 to about 1.7 mol % Co₃O₄.

19: The glass frit composition of claim 13, comprising:
about 5 to about 10 mol % Li₂O,
about 3 to about 7 mol % Na₂O,
about 30 to about 55 mol % SiO₂,
about 1 to about 15 mol % B₂O₃,
about 0.1 to about 2 mol % Al₂O₃,
about 1 to about 16 mol % TiO₂,
about 4.7 to about 6.1 mol % MnO₂,
about 2.3 to about 11.8 mol % Fe₂O₃, and
about 1.5 to about 2.1 mol % Co₃O₄, and further comprising:
about 10 to about 20 mol % Bi₂O₃, and
about 0 to about 15 mol % ZnO.

20: The glass frit composition of claim 19, comprising:
about 7 to about 9 mol % Li₂O,
about 4 to about 6 mol % Na₂O,
about 40 to about 45 mol % SiO₂,
about 2 to about 5 mol % B₂O₃,
about 0.9 to about 1.2 mol % Al₂O₃,
about 4 to about 9.5 mol % TiO₂,
about 4.8 to about 5.8 mol % MnO₂,
about 2.3 to about 7.7 mol % Fe₂O₃,
about 1.6 to about 2 mol % Co₃O₄, and
about 14 to about 17 mol % Bi₂O₃,

21: The glass frit composition of claim 20, comprising:
about 7.2 to about 7.5 mol % Li₂O,
about 4.7 to about 5 mol % Na₂O,
about 38 to about 40 mol % SiO₂,
about 4 to about 12 mol % B₂O₃,
about 0.9 to about 1.1 mol % Al₂O₃,
about 8 to about 14 mol % TiO₂,
about 5 to about 5.3 mol % MnO₂,
about 6.6 to about 7 mol % Fe₂O₃,
about 1.6 to about 1.8 mol % Co₃O₄, and
about 14.8 to about 15.5 mol % Bi₂O₃.

22: The glass frit composition of claim 20, comprising:
about 6.9 to about 7.5 mol % Li₂O,
about 4.5 to about 5 mol % Na₂O,
about 37 to about 40 mol % SiO₂,
about 4 to about 4.5 mol % B₂O₃,
about 0.9 to about 1.1 mol % Al₂O₃,
about 8 to about 9 mol % TiO₂,
about 4.5 to about 5.5 mol % MnO₂,
about 6.3 to about 7.1 mol % Fe₂O₃
about 1.6 to about 1.8 mol % Co₃O₄,
about 14 to about 16 mol % Bi₂O₃, and
about 3.7 to about 10.8 mol % ZnO.

23: The glass frit composition of claim 20, comprising:
about 7.3 to about 8.7 mol % Li₂O,
about 4.8 to about 5.8 mol % Na₂O,
about 35 to about 40 mol % SiO₂,
about 4.3 to about 5.2 mol % B₂O₃,
about 1 to about 1.2 mol % Al₂O₃,
about 8.5 to about 10.5 mol % TiO₂,
about 5 to about 6.2 mol % MnO₂,
about 8 to about 12 mol % Fe₂O₃
about 1.7 to about 2.1 mol % Co₃O₄, and
about 15 to about 18 mol % Bi₂O₃.

24: An enamel composition comprising, prior to firing, an organic vehicle, an optional pigment and the glass frit composition of claim 13.

25: An enamel composition comprising, prior to firing, an organic vehicle, an optional pigment and the glass frit composition of claim 15.

26: An enamel composition comprising, prior to firing, an organic vehicle, an optional pigment and the glass frit composition of claim 17.

27: An enamel composition comprising, prior to firing, an organic vehicle, an optional pigment and the glass frit composition of claim 19.

28: An enamel composition comprising, prior to firing, an organic vehicle, an optional pigment and the glass frit composition of claim 21.

29: An enamel composition comprising, prior to firing, an organic vehicle, an optional pigment and the glass frit composition of claim 23.

30: An enamel composition comprising, prior to firing,
an organic vehicle,
an optional pigment and
the glass frit composition of claim 14 and
a second glass frit composition comprising:
about 6.9 to about 8.6 mol % Li₂O,
about 4.7 to about 5.7 mol % Na₂O,
about 35 to about 46.8 mol % SiO₂,
about 4.1 to about 11.7 mol % B₂O₃,
about 0.9 to about 1.2 mol % Al₂O₃,
about 4.5 to about 13.6 mol % TiO₂,
about 4.9 to about 6.1 mol % Fe₂O₃
about 2.4 to about 11.7 mol % MnO₂,
about 1.6 to about 2 mol % Co₃O₄, and
about 14.6 to about 17.9 mol % Bi₂O₃.

31: The enamel composition of claim 30 wherein the second glass frit further comprises about 3.9 to about 10.7 mol % ZnO.

32: An enamel composition comprising, prior to firing,
an organic vehicle,
an optional pigment and
the glass frit composition of claim 15 and
a second glass frit composition comprising:
about 5 to about 10 mol % Li₂O,
about 3 to about 7 mol % Na₂O,
about 30 to about 55 mol % SiO₂,
about 1 to about 15 mol % B₂O₃,
about 0.1 to about 2 mol % Al₂O₃,
about 1 to about 16 mol % TiO₂,
about 4.7 to about 6.1 mol % MnO₂,
about 2.3 to about 11.8 mol % Fe₂O₃,
about 1.5 to about 2.1 mol % Co₃O₄,
about 10 to about 20 mol % Bi₂O₃, and
about 0 to about 15 mol % ZnO.

33: The enamel composition of claim 32 wherein ZnO is present in the second glass frit at an amount of from about 3.9 to about 10.7 mol %.

34: An enamel composition comprising, prior to firing,
an organic vehicle,
an optional pigment and
the glass frit composition of claim 16 and
a second glass frit composition comprising:
about 6.9 to about 8.6 mol % Li₂O,
about 4.7 to about 5.7 mol % Na₂O,
about 35 to about 46.8 mol % SiO₂,
about 4.1 to about 11.7 mol % B₂O₃,
about 0.9 to about 1.2 mol % Al₂O₃,
about 4.5 to about 13.6 mol % TiO₂,
about 4.9 to about 6.1 mol % Fe₂O₃
about 2.4 to about 11.7 mol % MnO₂,
about 1.6 to about 2 mol % Co₃O₄, and
about 14.6 to about 17.9 mol % Bi₂O₃.

35: The enamel composition of claim 34 wherein the second glass frit further comprises about 3.9 to about 10.7 mol % ZnO.

36: An enamel composition comprising, prior to firing,
an organic vehicle,
an optional pigment and
the glass frit composition of claim 18 and
a second glass frit composition comprising:
about 5 to about 10 mol % Li₂O,
about 3 to about 7 mol % Na₂O,
about 30 to about 55 mol % SiO₂,
about 1 to about 15 mol % B₂O₃,
about 0.1 to about 2 mol % Al₂O₃,
about 1 to about 16 mol % TiO₂,
about 4.7 to about 6.1 mol % MnO₂,
about 2.3 to about 11.8 mol % Fe₂O₃,
about 1.5 to about 2.1 mol % Co₃O₄,
about 10 to about 20 mol % Bi₂O₃, and
about 0 to about 15 mol % ZnO.

37: A method of decorating a substrate, comprising:
providing a substrate bearing an enamel comprising, prior to firing,
the glass frit composition of claim 13,
an optional pigment, and
an organic vehicle, and
firing the enamel composition and the substrate at a temperature within the range of about 500° C. to about 735° C. to adhere the enamel composition to the substrate,
